(19) United States
(12) Patent Application Publication
(10) Pub. No.: US 2012/0163157 A1
(43) Pub. Date: Jun. 28, 2012

(54) Optical Element and Optical Pickup Device

(75) Inventors: Katsuhiko Hayashi, Nara (JP); Yasuhiro Tanaka, Hyogo (JP); Michihiro Yamagata, Osaka (JP); Yoshiaki Komma, Osaka (JP)

(73) Assignee: Panasonic Corporation, Osaka (JP)

(21) Appl. No.: 13/411,656

(22) Filed: Mar. 5, 2012

Related U.S. Application Data
(63) Continuation of application No. PCT/JP2010/005684, filed on Sep. 17, 2010.

(30) Foreign Application Priority Data
Sep. 17, 2009 (JP) 2009-216230

(51) Int. Cl. G11B 7/1374; G02B 5/18

(52) U.S. Cl. 369/112.23; 359/571; G9B/7.121; G9B/7.123

(57) ABSTRACT

An optical element which can be shared by three wavelengths for BD, DVD, and CD and which is easily manufactured is provided. An objective lens system includes an optical element 1A and a converging lens element 1B. A first surface of the optical element 1A on an incident side is concentrically divided into a region 11 including a rotational symmetry axis, a region 12, and a region 13. On the optical element 1A, a periodic stair-like diffraction structure and a periodic sawtooth-like diffraction structure are provided. A second surface of the optical element 1A is divided into a region 21 including a rotational symmetry axis, a region 22, and a region 23. On the region 21, a sawtooth-like diffraction structure is provided. The converging lens element 1B converges light having passed through the optical element 1A, to form a spot on an information recording surface of an optical disc.

### CROSS-REFERENCE TO RELATED APPLICATION

This application is a U.S. continuation application filed under 35 USC 111(a) claiming benefit under 35 USC 120 and 365(c) of PCT application JP2010/005684, filed Sep. 17, 2010, which claims priority to Japanese Patent Application No. 2009-216230, filed on Sep. 17, 2009. The foregoing applications are hereby incorporated herein by reference.

### BACKGROUND OF THE INVENTION

1. Field of the Invention

The present invention relates to an optical element and an optical pickup device used for performing at least one of recording, reproducing, and erasing of information on an optical disc.

2. Description of the Background Art

In recent years, research and development have been actively carried out concerning high-density optical discs that have an increased storage capacity by using a blue laser beam with a wavelength of about 400 nm. One of the standards of such high-density optical discs is a standard (Blu-Ray Disc (registered trademark; hereinafter, referred to as “BD”)) in which the image side numerical aperture (NA) of an objective lens is set to about 0.85 and the thickness of a protective base plate formed on an information recoding surface of an optical disc is set to about 0.1 mm. In addition, DVD, which is a standard in which a red laser beam with a wavelength of about 680 nm is used and the thickness of a protective base plate formed on an information recording surface of an optical disc is set to about 0.6 mm, and CD, which is a standard in which an infrared laser beam with a wavelength of about 780 nm is used and the thickness of a protective base plate is set to about 1.2 mm, are also used. Thus, objective lens have been developed which can be used for BD as well as DVD and CD.

For example, Japanese Laid-Open Patent Publication No. 2006-209934 discloses an optical pickup device having compatibility with three types of wavelengths for BD, DVD, and CD. In the optical pickup device disclosed in Japanese Laid-Open Patent Publication No. 2006-209934, two optical elements, namely, a compatible optical element providing compatibility with three wavelengths and an objective lens element optimized for BD, are used in combination. The compatible optical element has diffraction structures on both surfaces on an incident side and an exit side, and compensates a spherical aberration which occurs during recording or reproducing on an optical disc of a different standard, by using a difference in diffraction angle caused by a difference in wavelength.

However, in the optical pickup device disclosed in Japanese Laid-Open Patent Publication No. 2006-209934, it is necessary to ensure a sufficient working distance (hereinafter, referred to as WD) suitable for CD. Thus, it is necessary to increase the WD of the objective lens element optimized for BD or to increase the focal length thereof. In this case, the manufacturing tolerance of the objective lens element is very strict and manufacturing is difficult.

### SUMMARY OF THE INVENTION

It is an object of the present invention to provide an optical element which can be shared by three wavelengths for BD, DVD, and CD and which is easily manufactured.

An optical element according to the present invention has a plurality of periodic stair-like structures and a periodic sawtooth-like structure on a first optical surface.

According to the present invention, an optical element can be realized which has compatibility with three wavelengths for BD, DVD, and CD and which can easily be manufactured.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1A is a diagram schematically illustrating a diffraction structure provided on an optical element according to Embodiment 1;

FIG. 1B is a diagram schematically illustrating a diffraction structure provided on an optical element according to Embodiment 1;

FIG. 1C is a diagram schematically illustrating a diffraction structure provided on an optical element according to Embodiment 1;

FIG. 1D is a diagram schematically illustrating a diffraction structure provided on an optical element according to Embodiment 1;

FIG. 2 is a diagram showing an arrangement of a stair-like diffraction structure and a sawtooth-like diffraction structure provided on the optical element according to Embodiment 1;

FIG. 3 is a schematic configuration diagram of an objective optical system according to Embodiment 1;

FIG. 4 is a schematic configuration diagram of an optical pickup device according to Embodiment 2;

FIG. 5 is an optical path diagram (BD) of the objective optical system according to Numerical Example 1;

FIG. 6 is an optical path diagram (DVD) of the objective optical system according to Numerical Example 1;

FIG. 7 is an optical path diagram (CD) of the objective optical system according to Numerical Example 1;

FIG. 8 is a spherical aberration diagram (BD) oft the objective optical system according to Numerical Example 1;

FIG. 9 is a spherical aberration diagram (DVD) of the objective optical system according to Numerical Example 1;

FIG. 10 is a spherical aberration diagram (CD) of the objective optical system according to Numerical Example 1;

FIG. 11 is an aberration diagram (BD) of a sine condition of the objective optical system according to Numerical Example 1;

FIG. 12 is an aberration diagram (DVD) of a sine condition of the objective optical system according to Numerical Example 1;

FIG. 13 is an aberration diagram (CD) of a sine condition ‘of the objective optical system according to Numerical Example 1;

FIG. 14 is an optical path diagram (BD) of an objective optical system according to Numerical Example 2;

FIG. 15 is an optical path diagram (DVD) of the objective optical system according to Numerical Example 2;

FIG. 16 is an optical path diagram (CD) oft the objective optical system according to Numerical Example 2;

FIG. 17 is a spherical aberration diagram (BD) of the objective optical system according to Numerical Example 2;

FIG. 18 is a spherical aberration diagram (DVD) of the objective optical system according to Numerical Example 2;

FIG. 19 is a spherical aberration diagram (CD) of the objective optical system according to Numerical Example 2;

FIG. 20 is an aberration diagram (BD) of a sine condition of the objective optical system according to Numerical Example 2;

FIG. 21 is an aberration diagram (DVD) of a sine condition of the objective optical system according to Numerical Example 2; and

FIG. 22 is an aberration diagram (CD) of a sine condition of the objective optical system according to Numerical Example 2.

### DESCRIPTION OF THE PREFERRED EMBODIMENTS

### Embodiment 1

An objective optical system according to Embodiment 1 is composed of a converging lens element (objective lens element) which is disposed so as to face an incident surface of an optical disc, and an optical element for phase compensation, which is disposed on the light source side of the converging lens element. A first surface of the optical element on an incident side is a composite structure surface on which a stair-like diffraction structure and a sawtooth-like diffraction structure are provided, and a second surface of the optical element is a composite structure surface which is composed of a sawtooth-like diffraction structure and an aspheric surface shape. A first surface of the converging lens element on an incident side and a second surface relative to the converging lens element are aspheric surfaces.

A stair-like diffraction structure is a periodic structure whose cross-sectional shape is a stair-like shape and which has flat surfaces perpendicular to the optical axis, and refers to a so-called binary type diffraction structure. By adjusting the depth of one step (unit step), it is possible to provide wavelength selectivity. Meanwhile, a sawtooth-like diffraction structure refers to a diffraction structure of a relief shape.

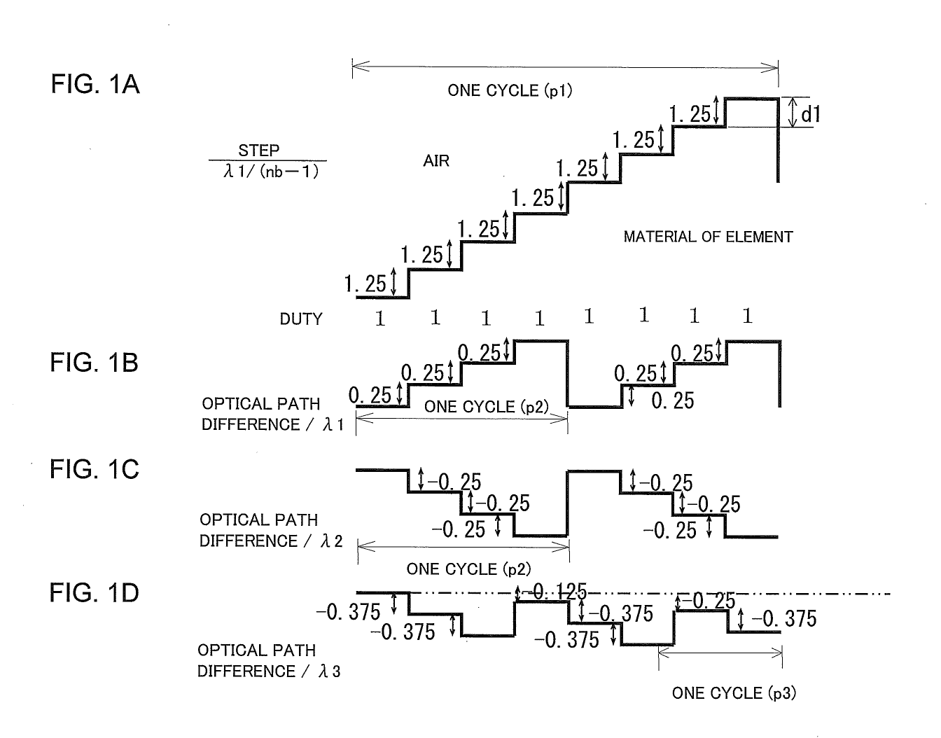

FIG. 1 is a diagram schematically illustrating a diffraction structure provided on the optical element according to Embodiment 1. The optical element has a periodic structure. FIG. 1A is a diagram illustrating a cross section of one cycle of a stair-like diffraction structure provided on the first surface of the optical element. FIG. 1A shows the physical shape of a grating formed on a base material. FIG. 1B shows an amount of phase change with respect to blue light. FIG. 1C shows an amount of phase change with respect to red light. FIG. 1D shows an amount of phase change with respect to infrared light.

In FIG. 1A, the vertical direction indicates the thickness (height) of the base material in the optical axis direction. In this embodiment, a polyolefin resin whose nb is about 1.522 is used as the base material, and the height d1 of one step is set to 0.96 μm. Here, nb is the refractive index of the material with respect to a blue light beam. The height of this step is set such that the length of the optical path [d1/λ1×(nb−1)] when the blue light beam is used is about 1.25, namely, a phase difference is about (2π+π/2). The refractive index nr of the above material with respect to a red light beam is about 1.505, and thus the length of the optical path at the step [d1/λ2×(nr−1)] when the red light is used is about 0.75 and corresponds to about −2π/2 in phase difference. Similarly, the refractive index ni of the above material with respect to an infrared light beam is about 1.501, and thus the length of the optical path at the step [d1/λ3×(ni−1)] when the infrared light is used is about 0.625 and corresponds to about −3π/4 in phase difference.

When a stair-like step structure in which the height increases by d1 per step is provided as shown in FIG. 1A, an amount of phase change with respect to the blue light beam is π/2 per step as shown in FIG. 1B. In other words, the optical path length changes by +¼ of the wavelength λ1 per step. The phase changes by 2π per four steps, and the diffraction efficiency of +1st order diffracted light is about 80% (scalar calculation) and is at its maximum. In the step structure of FIG. 1A, eight steps constitute one cycle p1. Since the phase changes by 2π per four steps, a phase change of two cycles of a cycle p2 (p2 is half of p1) occurs in blue light within one cycle p1 of steps. When the step structure is taken as a periodic structure of a cycle p1, for blue light, the diffraction efficiency of +2nd order diffracted light is about 80% and is the highest.

With respect to a red light beam, an amount of phase change is π/2 per step as shown in FIG. 1C. In other words, the optical path length changes by −¼ of λ2 per step. The phase changes by −2π per four steps, and the diffraction efficiency of −1st order diffracted light is about 80% (scalar calculation) and is at its maximum. In the step structure of FIG. 1A, the phase changes by −2π per four steps, and thus a phase change of two cycles of the cycle p2 (p2 is half of p1) occurs in red light within one cycle p1 of steps. When the step structure is taken as a periodic structure of a cycle p1, for red light, the diffraction efficiency of −2nd order diffracted light is about 80% and is the highest. Here, a negative diffraction order means that light bends in a direction opposite to that when a diffraction order is positive.

With respect to an infrared light beam, an amount of phase change is −3π/4 per step as shown in FIG. 1D. In other words, the optical path length changes by −⅜ of λ3 per step. In the step structure of FIG. 1A, the phase changes by −3/2π per four steps, and thus a phase change of three cycles of a cycle p3 (p3 is ⅓ of p1) occurs in infrared light within one cycle p1 of steps. When the step structure is taken as a periodic structure of a cycle p1, for infrared light, the diffraction efficiency of −3rd order diffracted light is about 60% and is the highest.

In other words, when the step structure shown in FIG. 1A is provided on an optical surface, the optical surface wavelength-selectively serves as a surface having positive power with respect to a blue light beam and as a surface having negative power with respect to a red light beam and an infrared light beam.

In the present embodiment, the combination of the optical element and the converging lens element optimized for BD is used. In order to ensure a sufficient working distance (WD) when CD having the thickest protective base plate is used, it is necessary to ensure a large WD even for the converging lens element dedicated for BD. In order to increase the WD, the focal length is lengthened or the lens is thinned. When the focal length is lengthened, an optical system and an optical pickup are increased in size, which is inconvenient. Meanwhile, when the lens is thinned, the off-axis characteristics of the lens deteriorate, and thus an aberration occurring due to manufacturing reasons is great and recording and reproducing are difficult. Therefore, the focal length and WD of the converging lens element dedicated for BD have to be reduced as much as possible.

In contrast, when a stair-like diffraction structure is used, it is possible to set power by a diffraction effect to be positive for a blue light beam and to be negative for red and infrared light beams, which is convenient.

When the steps are designed so as to provide positive power to a blue light beam, an effect of compensating an on-axis chromatic aberration is obtained when BD is used. At the same time, it is possible to perform designing so as to provide negative power to a red light beam and an infrared light beam. Thus, a composite focal length when DVD and CD are used can be increased, and a sufficient WD can be ensured.

Further, the converging lens element dedicated for BD refers to an objective lens element optimized for BD, and specifically refers to an objective lens element which has an NA of 0.85 and which, with respect to light with a wavelength of 408 nm, forms a spot which is favorably aberration-compensated, on an information recording surface of an optical disc having a protective base plate thickness of 0.1 mm. However, here, in order to enable recording and reproducing on a BD disc having information recording surfaces of two layers, the central protective base plate thickness at designing is set to 87.5 μm. In addition, a collimating lens is inserted between a light source and the objective lens system. When recording or reproducing is performed on BD, the collimating lens is moved along the optical axis direction to perform spherical aberration compensation. When recording or reproducing is performed on DVD, the collimating lens is moved along the optical axis direction to cause converging light to be incident on the objective lens system. When recording or reproducing is performed on CD, the collimating lens is moved along the optical axis direction to cause diverging light to be incident on the objective lens system.

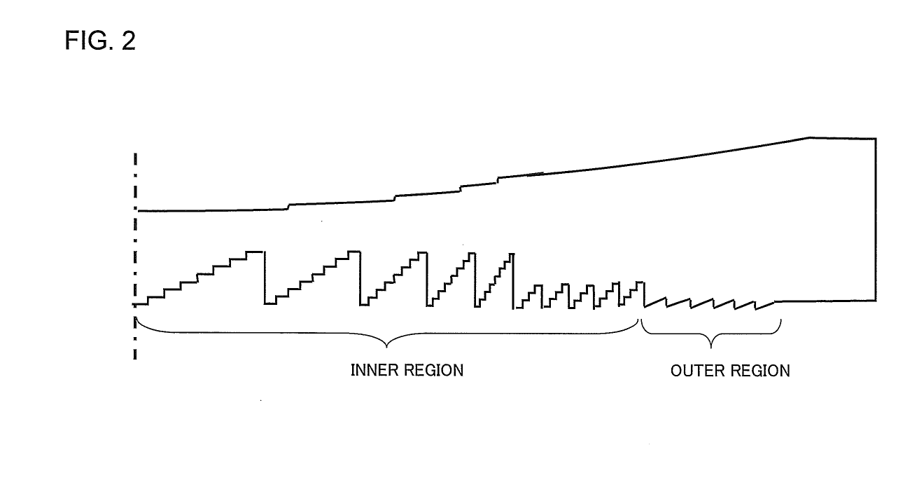

FIG. 2 is a diagram showing an arrangement of a stair-like diffraction structure and a sawtooth-like diffraction structure provided on the optical element according to Embodiment 1.

An optical surface of the optical element is divided into a circular inner region including a rotational symmetry axis (a chain line in FIG. 2), and a ring-shaped outer region surrounding the inner region. The stair-like step structure shown in FIG. 1A is provided on the inner region, and a sawtooth-like diffraction structure is provided on the outer region. The region having the sawtooth-like diffraction structure is a region dedicated for BD. Thus, the blaze wavelength is set such that a high diffraction efficiency can be obtained for the wavelength for BD and a low diffraction efficiency is obtained for the wavelengths for DVD and CD. In addition, the sawtooth-like diffraction structure of the outer region is designed such that an aberration which occurs when light of the wavelength for BD is converged is compensated and light of the wavelengths for DVD and CD is converted to a flare which does not contribute to spot performance, whereby an aperture limiting function is provided.

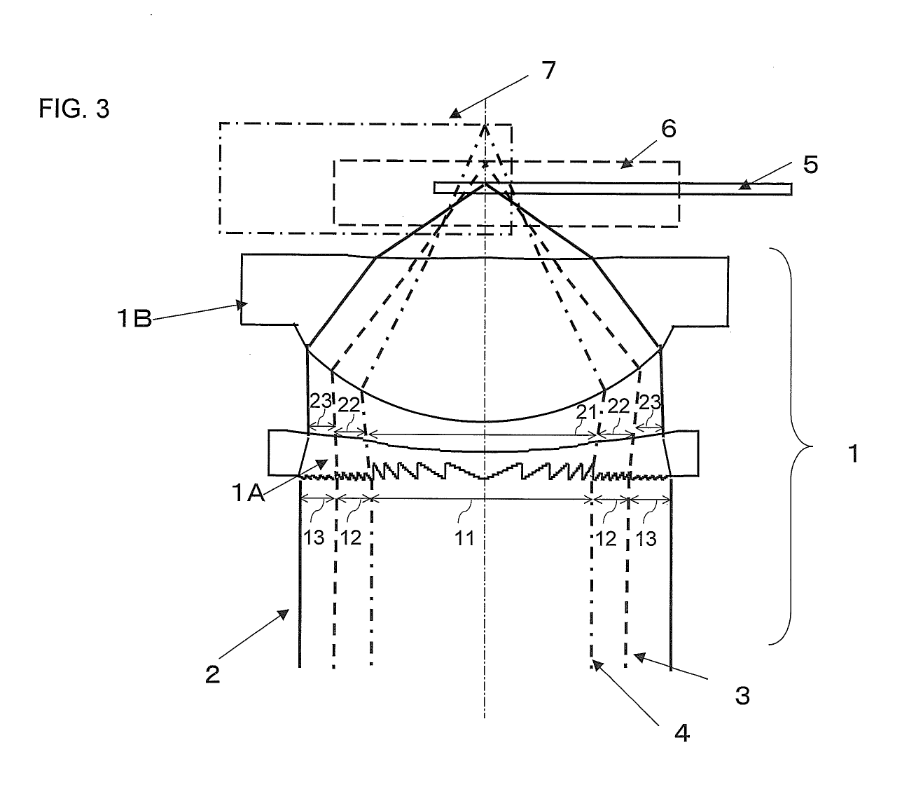

FIG. 3 is a schematic configuration diagram of the objective optical system according to Embodiment 1.

As shown in FIG. 3, when recording or reproducing is performed on BD, a light beam 2 with a wavelength of 408 nm, which is emitted from a light source and collimated, is incident on an optical element 1A of the objective lens system 1. The stair-like diffraction structure and sawtooth-like diffraction structure described above are provided on a first surface of the optical element 1A. The first surface of the optical element 1A is divided into three concentric regions; namely, a region 11 including a rotational symmetry axis (a chain line), a region 12 surrounding the region 11, and a region 13 surrounding the region 12. The regions 11 and 12 correspond to the inner region shown in FIG. 2, and the region 13 corresponds to the outer region shown in FIG. 2.

The region 11 is a region shared by the three wavelengths for CD, DVD, and BD. On the region 11, a stair-like diffraction structure is formed in which the height of each step is 0.96 μm and one cycle is composed of eight steps.

The region 12 is a region shared by the two wavelengths for DVD and BD. On the region 12, a stair-like diffraction structure is formed in which the height of each step is 0.96 μm and one cycle is composed of four steps.

The region 13 is a region dedicated for BD. On the region 13, a sawtooth-like diffraction structure having a blaze depth of 0.78 μm is formed. The blaze depth suffices to be an integral multiple of 0.78 μm.

The light beam 2 for BD is diffracted at the first surface of the optical element 1A. At the regions 11, 12, and 13, the diffraction efficiencies of +2nd order diffracted light, +1st order diffracted light, and +1st order diffracted light are at their maximum, respectively, and these light is used as signal light. At each of the regions 11 to 13, the light beam 2 receives positive power by the diffraction.

Next, the light beam 2 passes through a second surface of the optical element 1A. Similarly to the first surface, the second surface of the optical element 1A is divided into three regions concentric with a rotational symmetry axis, namely, a region 21 including the rotational symmetry axis, a region 22 surrounding the region 21, and a region 23 surrounding the region 22.

The region 21 has a sawtooth-like diffraction structure. The region 21 is a region shared by the three wavelengths for CD, DVD, and BD. In the region 21, on-axis spherical aberration compensation cannot be sufficiently performed on light of all the three wavelengths by only the stair-like diffraction structure of the first surface, and a slight spherical aberration remains. Thus, spherical aberration compensation is performed by the sawtooth-like diffraction structure of the region 21. This diffraction structure is a normal sawtooth-like diffraction structure, and is a relief-like diffraction structure of which the blaze depth is optimized in order to obtain an optimum diffraction efficiency for all the wavelengths. The light beam 2 is diffracted at the region 21, and +2nd order diffracted light having a maximum diffraction efficiency is used as signal light. The diffractive surface shape of the region 21 is appropriately designed such that an off-axis aberration becomes minimum at all formats.

The region 22 is formed by an aspheric surface. The region 22 is a region shared by the two wavelengths for DVD and BD. In the region 22, an on-axis spherical aberration is compensated by only the stair-like diffraction structure of the first surface. The aspheric surface shape is appropriately designed such that an off-axis aberration becomes minimum when BD and DVD are used.

The region 23 is formed by an aspheric surface. The region 23 is a region dedicated for BD. The aspheric surface shape is appropriately designed such that on-axis and off-axis aberrations are reduced when BD is used. The light beam 2 is refracted at the regions 22 and 23.

Next, the light having passed through the optical element 1A is incident on a converging lens element 1B optimized for BD and is favorably converged on an information recording surface of a BD disc 5. Then, the light beam 2 reflected by the information recording surface passes through the converging lens element 1B again, similarly passes through the optical element 1A, and is converged by a relay lens (not shown) on a detector.

When DVD is used, a light beam 3 with a wavelength of 658 nm, which is emitted from a light source and collimated, is incident on the optical element 1A of the objective lens system 1. Then, the light beam 3 is diffracted at the first surface of the optical element 1A. At the regions 11 and 12, the diffraction efficiencies of −2nd order diffracted light and −1st order diffracted light are at their maximum, respectively, and thus these light is used as signal light. Here, a negative diffraction order means that light bends in a direction opposite to that when a diffraction order is positive. In addition, a portion of the light beam 3 diffracted at the region 13 becomes a flare which does not contribute to a spot, and thus the region 13 exerts an aperture limiting function on red light.

Next, the light beam 3 is incident on the second surface of the optical element 1A. The light beam 3 is diffracted at the region 21 of the second surface and the diffraction efficiency of +1st order diffracted light is at its maximum, and thus this light is used as signal light. The light beam 3 is refracted by the aspheric surfaces at the regions 22 and 23.

Next, the light beam 3 having passed through the optical element 1A is incident on the converging lens element 1B optimized for BD and is favorably converged on an information recording surface of a DVD disc 6. Then, the light beam 3 reflected by the information recording surface passes through the converging lens element 1B again, passes through the optical element 1A, is converged by a collimating lens and a detection lens (not shown) on the detector, and is detected by the detector.

When CD is used, a light beam 4 with a wavelength of 785 nm, which is emitted from a light source and collimated, is incident on the optical element 1A of the objective lens system 1. Then, the light beam 4 is diffracted at the first surface of the optical element 1A. At the region 11, the diffraction efficiency of −3rd order diffracted light is at its maximum, and thus this light is used as signal light. At the region 12, the diffraction efficiency of −1st order diffracted light is at its maximum, but this light becomes a flare, since the diffraction efficiency is relatively low and a great spherical aberration occurs. In addition, the light beam 3 diffracted at the region 13 also becomes a flare which does not contribute to a spot. In this manner, the regions 12 and 13 exert an aperture limiting function on infrared light.

Next, the light beam 4 is incident on the second surface of the optical element 1A. At the region 21 of the second surface, the diffraction efficiency of +1st order diffracted light is at its maximum, and thus this light is used as signal light. At the regions 22 and 23, the light beam 4 is refracted by the aspheric surfaces.

The light beam 4 having passed through the optical element 1A is incident on the converging lens element 1B optimized for BD and is favorably converged on an information recording surface of a CD disc 7. Then, the light beam 4 reflected by the information recording surface passes through the converging lens element 1B again, passes through the optical element 1A, is converged by the collimating lens and the detection lens (not shown) on the detector, and is detected by the detector.

In the example of FIG. 3, on the first surface of the optical element 1A, the stair-like diffraction structures are provided on both the regions 11 and 12. However, it suffices that a stair-like diffraction structure is provided on at least the innermost region shared by the three wavelengths.

Further, it suffices that, on the second surface of the optical element 1A, a diffraction structure is provided on at least the region shared by the three wavelengths. However, a diffraction structure may be provided on another region. In addition, in the above example, +2nd order for BD, +1st order for DVD, and +1st order for CD are used as a combination of diffraction orders in the second surface of the optical element 1A, but the combination is not limited thereto. However, this combination of diffraction orders is preferable, since the maximum diffraction efficiency is obtained for light of all the wavelengths.

Further, in the present embodiment, as light made incident on the objective lens system, substantially parallel light is used when BD is used, and converging or diverging light is used when DVD or CD is used, but the incident light is not limited to these examples. However, when a light beam incident on the objective lens system diverges or converges, if the objective lens system shifts at tracking on BD, a coma aberration occurs and stable recording and reproducing are difficult. Thus, when BD is used, it is desired to cause substantially parallel light to be incident on the objective lens system.

### Embodiment 2

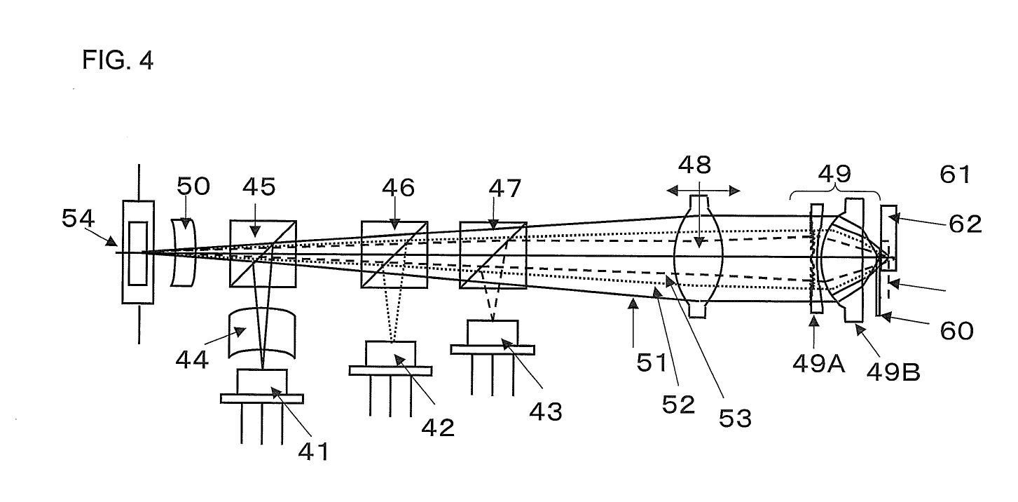

FIG. 4 is a schematic configuration diagram of an optical pickup device according to Embodiment 2.

The optical pickup device shown in FIG. 4 is compatible with the three wavelengths for BD, DVD, and CD, and includes a light source 41 (e.g., a wavelength of 408 nm), a light source 42 (e.g., a wavelength of 658 nm), a light source 43 (e.g., a wavelength of 785 nm), a beam shaping lens 44, polarizing beam splitters 45, 46, and 47, a collimating lens 48, an objective lens system 49, a detection lens 50, and a detector 54. The objective lens system 49 has the same configuration as that of Embodiment 1, and is composed of an optical element 49A and a converging lens element 49B dedicated for BD. The optical element 49A has a plurality of stair-like diffraction structures and a sawtooth-like diffraction structure on a first surface, and has a sawtooth-like diffraction structure and an aspheric surface on a second surface. The principle of the stair-like diffraction structure has been described in Embodiment 1, and thus the repeated description is omitted.

On a region dedicated for BD (corresponding to the region 13 in Embodiment 1), a sawtooth-like diffraction structure may be provided or a stair-like diffraction structure may be provided. However, with the sawtooth-like diffraction structure, designing is possible such that a theoretical diffraction efficiency of 100% is obtained, and thus the sawtooth-like diffraction structure is suitable for the region through which only a light beam for BD passes. The diffraction structure provided on the region dedicated for BD is designed such that a chromatic aberration is reduced.

Further, instead of being divided into three regions, the first surface of the optical element 49A may be divided into two regions or may not be divided. However, since the types of the wavelengths of transmitted light are different for each region, it is preferred to divide the first surface into regions, in order to obtain the maximum diffraction efficiency.

Next, the second surface of the optical element 49A is divided into three concentric regions. On the innermost region (corresponding to the region 21 in Embodiment 1) including a rotational symmetry axis, a sawtooth-like diffraction structure is formed for compensating a spherical aberration which cannot be sufficiently compensated by the stair-like diffraction structure of the first surface. In order to obtain the maximum diffraction efficiency at the three wavelengths, the depth of each step of the sawtooth-like diffraction structure is set to about 1.6 μm. The depth also depends on the refractive index of the element material and a diffraction order to be used.

When BD is used, a light beam 51 emitted from the light source 41 is shaped by the beam shaping lens 44 into an elliptic beam, then is reflected by the polarizing beam splitter 45, is collimated by the collimating lens 48, and is incident on the optical element 49A.

The light beam 51 incident on the innermost region of the first surface of the optical element 49A is diffracted by the stair-like diffraction structure to be +2nd order diffracted light of which the diffraction efficiency is at its maximum.

The light beam 51 incident on the intermediate region surrounding the innermost region is diffracted by the stair-like diffraction structure to be +1st order diffracted light of which the diffraction efficiency is at its maximum.

The light beam 51 incident on the outer region surrounding the intermediate region is diffracted by the sawtooth-like diffraction structure to be +1st order diffracted light of which the diffraction efficiency is at its maximum.

Next, the light beam 51 is incident on the second surface of the optical element 49A. The light beam 51 incident on the innermost region of the second surface of the optical element 49A is diffracted by the sawtooth-like diffraction structure to be +2nd order diffracted light of which the diffraction efficiency is at its maximum.

Further, the light beam 51 incident on the intermediate region surrounding the innermost region and the outer region outside the intermediate region is refracted by the aspheric surface. The light beam 51 having passed through the optical element 49A is subsequently incident on the converging lens element 49B. The converging lens element 49B is an objective lens element which has two aspheric surfaces and is optimized for BD. The light beam 51 having passed through the converging lens element 49B is favorably converged on an information recording surface of a BD disc 60. The light beam 51 reflected by the information recording surface passes through the objective lens system 49, passes through the collimating lens 48 and the polarizing beam splitters 47, 46, and 45 in order, and is converged by the detection lens 50 on the detector 54.

For the purpose of compensating a spherical aberration which occurs when BD is used, the collimating lens 48 is moveable along the optical axis direction. Other than the collimating lens, for example, a liquid crystal, a beam expander, or a liquid lens may be used as long as it is capable of compensating a spherical aberration.

When DVD is used, a light beam 52 emitted from the light source 42 is reflected by the polarizing beam splitter 46, passes through the polarizing beam splitter 47, passes through the collimating lens 48, and is incident on the optical element 49A. The collimating lens 48 is moved along the optical axis direction to a predetermined position to cause converging light to be incident on the objective lens system 49. The light beam incident on the objective lens system 49 does not necessarily have to be the converging light beam. However, the converging light beam is preferably used since off-axis characteristics can favorably be corrected.

The light beam 52 is incident as the converging light on the optical element 49A of the objective lens system 49. Then, the light beam 52 is diffracted at the first surface of the optical element 49A. At the innermost region, the diffraction efficiency of −2nd order diffracted light is at its maximum, and at the intermediate region, the diffraction efficiency of −1st order diffracted light is at its maximum. The light beam 52 diffracted at the outer region becomes a flare which does not contribute to a spot, and thus the outer region exerts an aperture limiting function.

Next, the light beam 52 is incident on the second surface of the optical element 49A. The light beam 52 incident on the second surface is diffracted at the innermost region, and the diffraction efficiency of +1st order diffracted light is at its maximum. At the intermediate and outer regions, the light beam 52 is refracted by the aspheric surfaces.

Next, the light beam 52 having passed through the optical element 49A is incident on the converging lens element 49B optimized for BD and is favorably converged on an information recording surface of a DVD disc 61. Then, the light beam 52 reflected by the information recording surface passes through the converging lens element 49B, passes through the optical element 49A, passes through the collimating lens 48 and the polarizing beam splitters 47, 46, and 45 in order, is converged by the detection lens 50 on the detector 54, and is detected by the detector 54.

When CD is used, a light beam 53 emitted from the light source 43 is reflected by the polarizing beam splitter 47, passes through the collimating lens 48, and is incident on the optical element 49A. The collimating lens 48 is moved along the optical axis direction to a predetermined position to cause diverging light to be incident on the objective lens system 49. The light made incident on the objective lens system 49 does not necessarily have to be the diverging light, but is preferably used since a large working distance can be ensured when CD is used. The light beam 53 is incident as the diverging light on the optical element 49A of the objective lens system 49. Then, the light beam 53 is diffracted on the first surface side of the optical element 49A. At the innermost region, the diffraction efficiency of −3rd order diffracted light is at its maximum and thus this light is used. The light beam 53 diffracted at the intermediate and outer regions becomes a flare, and thus the intermediate and outer regions exert an aperture limiting function.

Next, the light beam 53 is incident on the second surface of the optical element 49A. The light beam 53 is diffracted at the innermost region of the second surface, and the diffraction efficiency of +1st order diffracted light is at its maximum. At the intermediate and outer regions, the light beam 53 is refracted.

Next, the light beam 53 having passed through the optical element 49A is incident on the converging lens element 49B optimized for BD and is favorably converged on an information recording surface of a CD disc 62. Then, the light beam 53 reflected by the information recording surface passes through the objective lens 49B again, passes through the optical element 49A, passes through the collimating lens 48 and the polarizing beam splitters 47, 46, and 45 in order, is converged by the detection lens 50 on the detector 54, and is detected by the detector 54.

The distances from the light sources 41, 42, and 43 to the objective lens are not limited to those illustrated in FIG. 4. In FIG. 4, an example of including three separate light sources is shown. However, one light source which can selectively emit light of three wavelengths may be used, or a light source which can selectively emit light of two wavelengths and a light source which emits light of a wavelength may be used in combination.

Further, in FIG. 4, only the one detector is shown. However, a plurality of detectors may be used. In this embodiment, the values of the step depths all depend on the refractive index of the element material, and thus are not limited to those illustrated.

### EXAMPLES

Hereinafter, Numerical Examples of the present invention will be specifically described with construction data, aberration diagrams, and the like.

In each Numerical Example, a surface to which an aspheric coefficient is provided indicates a refractive optical surface having an aspherical shape or a surface having a refraction function equal to that of an aspheric surface. The surface shape of an aspheric surface is defined by the following formula 1.

$$X = \frac{{C}_{j} {h}^{2}}{1 + \sqrt{1 - ( 1 + {k}_{j} ) {C}_{j}^{2} {h}^{2}}} + \sum {A}_{j , n} {h}^{n}$$

### Here,

X is the distance from an on-the-aspheric-surface point at a height h relative to the optical axis to a tangential plane at the top of the aspheric surface,

h is the height relative to the optical axis,

Cⱼ is the radius of curvature at the top of an aspheric surface of a lens jth surface (Cⱼ=1/Rⱼ),

kⱼ is the conic constant of the lens jth surface, and

A_{j,n} is the nth-order aspheric constant of the lens jth surface.

Further, a phase difference caused by a diffraction structure added to an optical surface is provided by the following formula 2.

φ(h)=ΣP_{j,m}h^{2m}

The meaning of each character in the formula 2 is as follows:

Φ(h) is a phase functio p,

h is the height relative to the optical axis, and

P_{j,m} is the 2mth-order phase function coefficient of the lens jth surface.

### Numerical Example 1

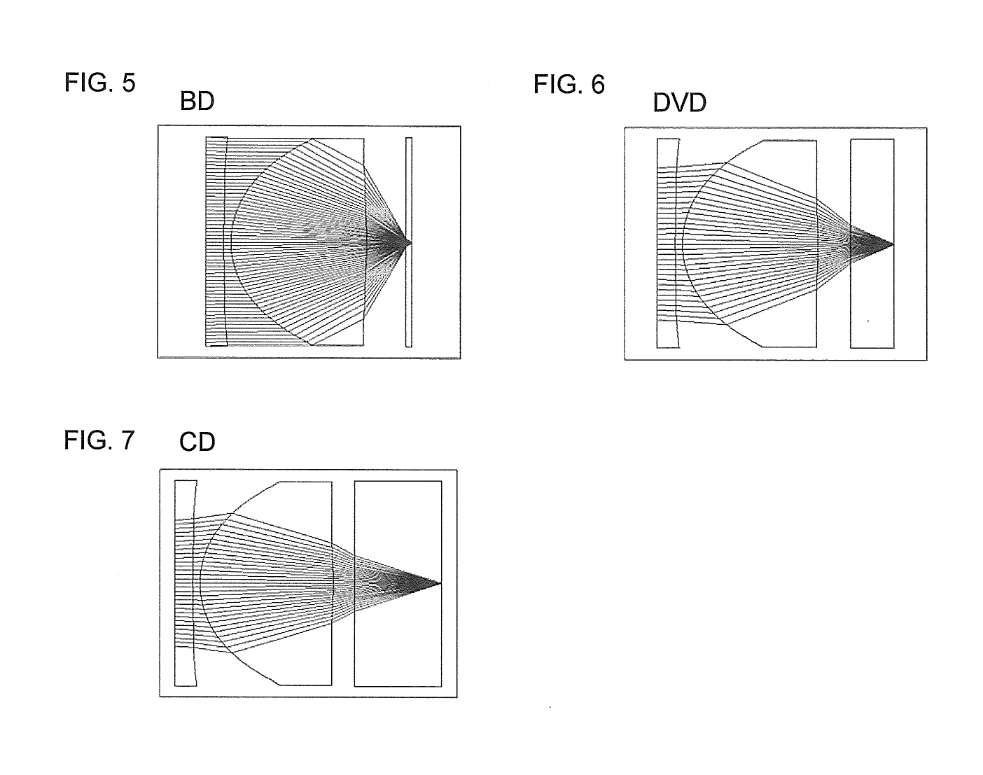

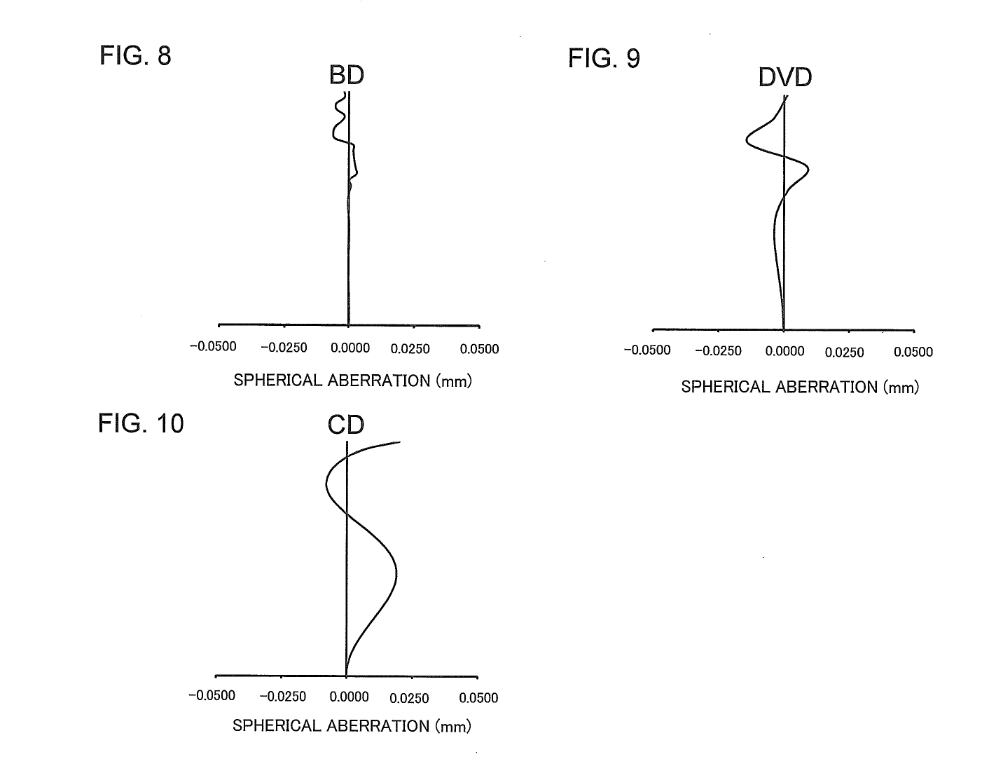

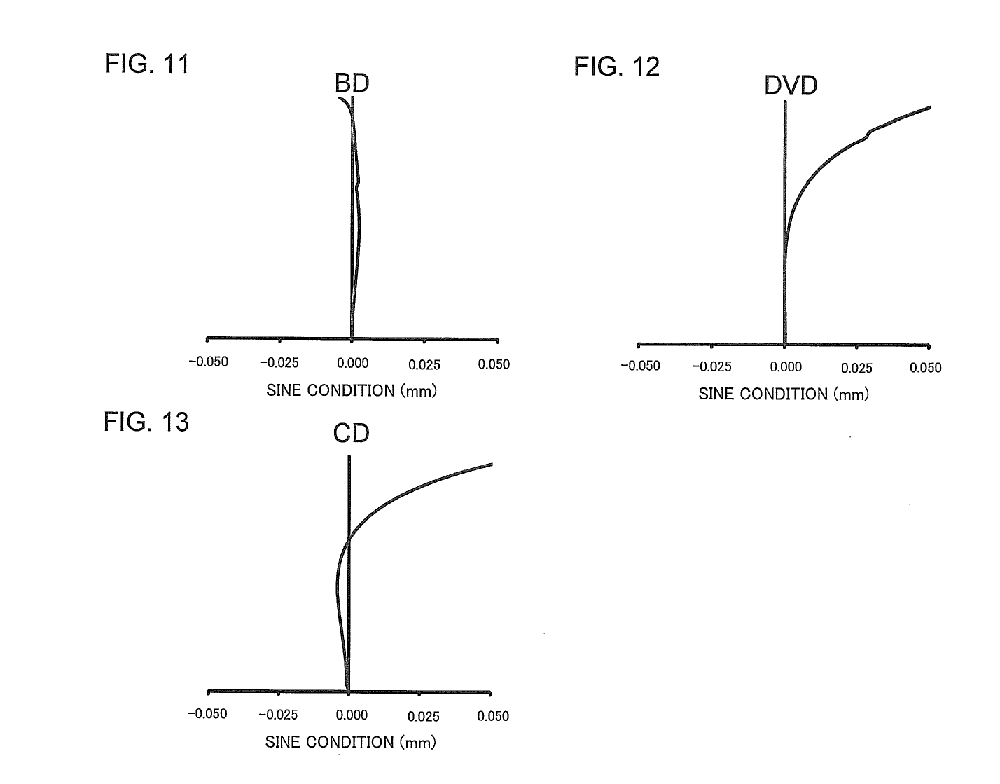

FIGS. 5 to 7 are optical path diagrams of an objective lens system according to Numerical Example 1; FIGS. 8 to 10 are spherical aberration diagrams of the objective lens system according to Numerical Example 1; and FIGS. 11 to 13 are aberration diagrams of sine conditions of the objective lens system according to Numerical Example 1.

Tables 1 to 3 shows designed values. As shown in Table 1, the designed wavelengths are 408 nm (BD), 658 nm (DVD), and 785 nm (CD); the disc base material thicknesses (designed central base material thicknesses) are 0.0875 mm (BD), 0.6 mm (DVD), and 1.2 mm (CD); the focal lengths are 1.6 mm (BD), 1.8 mm (DVD), and 1.9 mm (CD); the effective diameters are 2.78 mm (BD), 2.03 mm (DVD), and 1.71 mm (CD); the NAs are 0.86 (BD), 0.6 (DVD), and 0.47 (CD); the working distances are 0.53 mm (BD), 0.44 mm (DVD), and 0.30 mm (CD); and the element thicknesses are 0.25 mm (the optical element) and 1.84 mm (the converging lens element). The effective diameter is a value for the first surface (surface number 1 in Table 2) of the optical element.

In reality, the magnification is changed for each wavelength by using a magnification converting element such as a collimating lens, but only the distance of an optical virtual object point is shown here.

TABLE 1

| | BD | DVD | CD |
|---|---|---|---|
| Wavelength | 0.408 | 0.658 | 0.785 |
| Effective diameter | 2.78 | 2.03 | 1.71 |
| NA | 0.86 | 0.6 | 0.47 |
| Working distance (WD) | 0.53 | 0.44 | 0.3 |
| Disc thickness (DT) | 0.0875 | 0.6 | 1.2 |
| Focal length | 1.6 | 1.8 | 1.9 |
| Diffraction order of first | 2 | −2 | −3 |
| region on first surface | | | |
| Diffraction order of second | 1 | −1 | — |
| region on first surface | | | |
| Diffraction order of third | 1 | — | — |
| region on first surface | | | |
| Diffraction order of first | 2 | 1 | 1 |
| region on second surface | | | |
| Object point (OP) | ∞ | −70 | 100 |

TABLE 2

| | Radius of | | | |
|---|---|---|---|---|
| | curvature at | | | |
| Surface | the top of | | | |
| No. | lens surface | Thickness | Material | Remarks |
| 0 | | OP | | |
| 1 | ∞ | 0.25 | | First region (diffractive |
| | | | | surface), second region |
| | | | | (diffractive surface), third |
| | | | | region (diffractive surface) |
| 2 | 16.474198 | 0.1 | n1 | First region (diffractive |
| | | | | surface), second region |
| | | | | (aspherical surface), third |
| | | | | region (aspherical surface) |
| 3 | 1.11572 | 1.84 | n2 | Aspherical surface |
| 4 | −3.46178 | WD | | Aspherical surface |
| 5 | ∞ | DT | Disc | Planar |
| 6 | ∞ | | | Planar |

TABLE 3

| Wavelength | 408 | 658 | 785 |
|---|---|---|---|
| n1 | 1.52245912 | 1.50461749 | 1.50145399 |
| n2 | 1.62340933 | 1.60285214 | 1.59879881 |
| Disc | 1.61641628 | 1.5782857 | 1.57203127 |

Tables 4 to 6 show parameters of each surface of the optical element and the converging lens element.

TABLE 4

| First surface | First region, planar |
|---|---|
| | Diffractive surface |
| Region | 0 mm to 0.855 mm |
| R₁ | ∞ |
| First surface | First region, phase function |
| | Diffractive surface |
| P_{1, 2} | −122.79124 |
| P_{1, 4} | 2.0900937 |
| P_{1, 6} | −15.121872 |
| P_{1, 8} | 11.248045 |
| P_{1, 10} | −15.319841 |
| First surface | Second region, planar |
| Region | 0.855 mm to 1.015 mm |
| | Diffractive surface |
| R₁ | ∞ |
| First surface | Second region, phase function |
| | Diffractive surface |
| P_{1, 2} | −272.06268 |
| P_{1, 4} | 35.312378 |
| P_{1, 6} | −19.6378174 |
| P_{1, 8} | −3.6825958 |
| P_{1, 10} | 1.3743467 |
| First surface | Third region, planar |
| Region | 1.015 mm to 1.390 mm |
| | Diffractive surface |
| R₁ | ∞ |
| First surface | Second region, phase function |
| | Diffractive surface |
| P_{1, 2} | −272.06268 |
| P_{1, 4} | 35.312378 |
| P_{1, 6} | −19.6378174 |
| P_{1, 8} | −3.6825958 |
| P_{1, 10} | 1.3743467 |

TABLE 5

| Second surface | First region, aspherical constants |
|---|---|
| Region | 0 mm to 1 mm |
| | Diffractive surface |
| R₂ | 16.474198 |
| K₂ | 0.00000000 |
| A_{2, 2} | 0.00000000 |
| A_{2, 4} | 0.005482674 |
| A_{2, 6} | −0.043161593 |
| A_{2, 8} | 0.02410452 |
| A_{2, 10} | −0.04051103 |
| A_{2, 12} | 0.027556529 |
| A_{2, 14} | −0.027042205 |
| A_{2, 16} | 0.010105953 |
| Second surface | First region, phase function |
| | Diffractive surface |
| P_{2, 2} | 0 |
| P_{2, 4} | −25.379011 |
| P_{2, 6} | 194.18534 |
| P_{2, 8} | −108.46678 |
| P_{2, 10} | 133.03993 |
| Second surface | Second region, aspherical constants |
| Region | 1 mm to 1.16 mm |
| | Aspherical surface |
| R₂ | 16.013274 |
| K₂ | 0 |
| A_{2, 0} | −0.013539829 |
| A_{2, 2} | 0 |
| A_{2, 4} | 0.000751857 |
| A_{2, 6} | −0.005086009 |
| A_{2, 8} | 0.00805118 |
| A_{2, 10} | −0.004661375 |
| A_{2, 12} | 0.001113962 |
| A_{2, 14} | 6.33E−05 |
| A_{2, 16} | −4.53E−05 |
| Second surface | Third region, aspherical constants |
| Region | 1 mm to 1.16 mm |
| | Aspherical surface |
| R₂ | 19.192262 |
| K₂ | 0 |
| A_{2, 0} | −0.011276781 |
| A_{2, 2} | 0 |
| A_{2, 4} | 0.002593812 |
| A_{2, 6} | 0.00075214 |
| A_{2, 8} | −0.000643985 |
| A_{2, 10} | 0.000502779 |
| A_{2, 12} | −6.02E−05 |
| A_{2, 14} | −1.56E−05 |
| A_{2, 16} | 0 |

TABLE 6

| Third surface | Aspherical surface |
|---|---|
| R₃ | 1.11572 |
| K₃ | −0.5851429 |
| A_{3, 2} | 0.00000000 |
| A_{3, 4} | 0.010817277 |
| A_{3, 6} | 0.006059202 |
| A_{3, 8} | −0.003673222 |
| A_{3, 10} | 0.004797916 |
| A_{3, 12} | −0.000416935 |
| A_{3, 14} | −5.38E−05 |
| A_{3, 16} | −0.003036012 |
| A_{3, 18} | 0.00287972 |
| A_{3, 20} | −0.000816649 |
| A_{3, 22} | 0.00E+00 |
| Fourth surface | Aspherical surface |
| R₄ | −3.46178 |
| K₄ | 0 |
| A_{4, 2} | 0.00000000 |
| A_{4, 4} | 0.43114355 |
| A_{4, 6} | −0.84257129 |
| A_{4, 8} | 1.1266299 |
| A_{4, 10} | −0.96683661 |
| A_{4, 12} | 0.30912203 |
| A_{4, 14} | 0.20599138 |
| A_{4, 16} | −0.19747326 |
| A_{4. 18} | 0.030004312 |
| A_{4, 20} | 0.009468828 |
| A_{4, 22} | 0 |

### Numerical Example 2

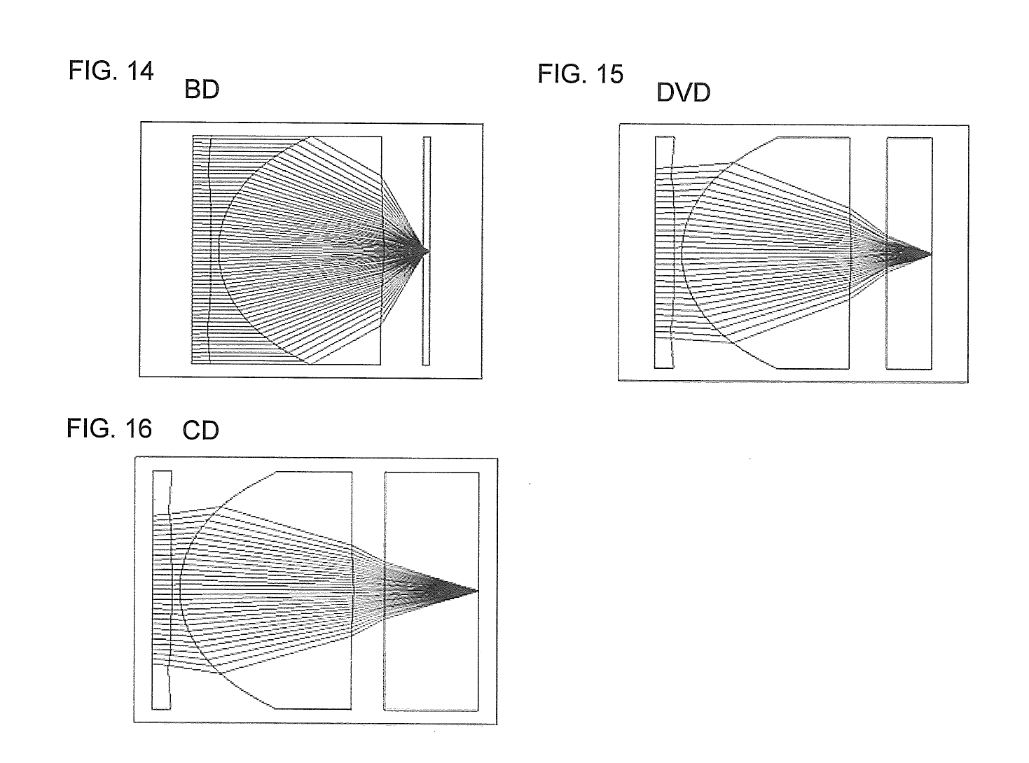

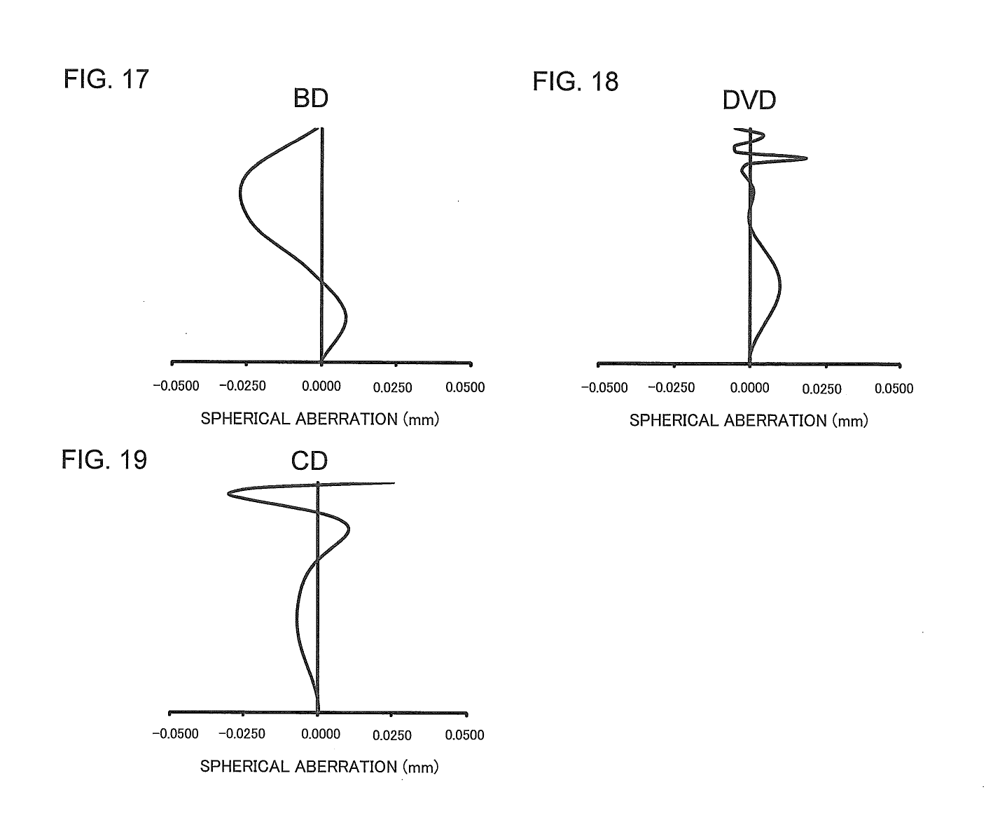

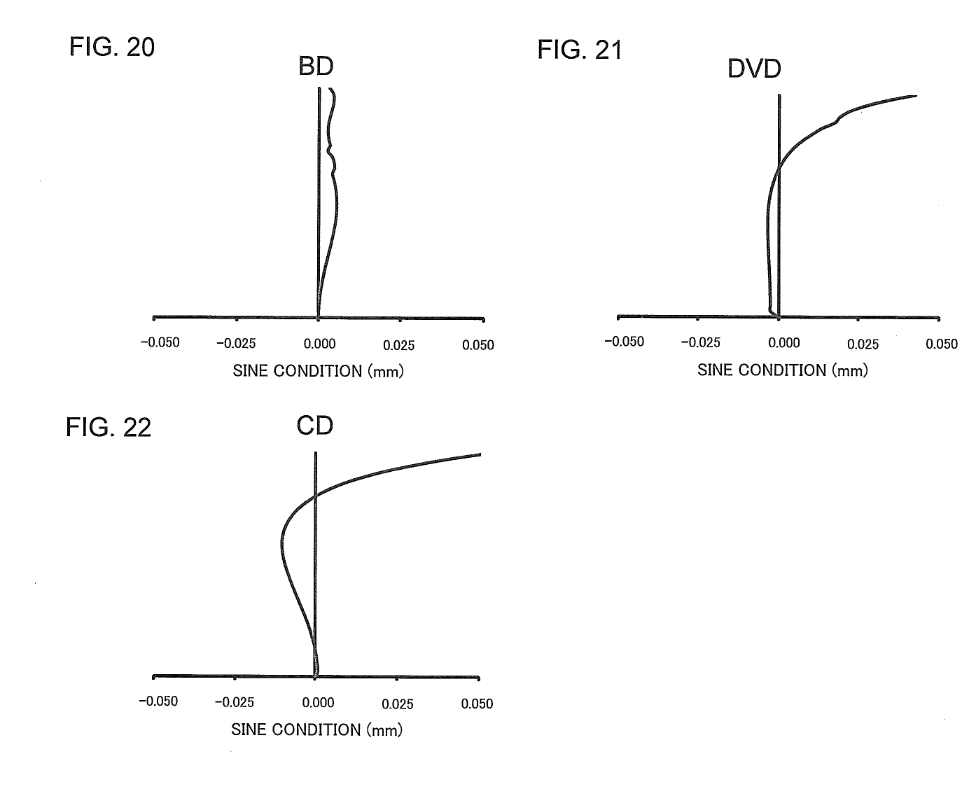

FIGS. 14 to 16 are optical path diagrams of an objective lens system according to Numerical Example 2; FIGS. 17 to 19 are spherical aberration diagrams of the objective lens system according to Numerical Example 2; and FIGS. 20 to 22 are aberration diagrams of sine conditions of the objective lens system according to Numerical Example 2.

Tables 7 to 9 shows designed values. As shown in Table 5, the designed wavelengths are 408 nm (BD), 658nm (DVD), and 785nm (CD); the disc base material thicknesses (designed central base material thicknesses) are 0.0875 mm (BD), 0.6 mm (DVD), and 1.2 mm (CD); the focal lengths are 1.8 mm (BD), 2.0 mm (DVD), and 2.2 mm (CD); the effective diameters are 3.10 mm (BD), 2.28 mm (DVD), and 1.94 mm (CD); the NAs are 0.86 (BD), 0.6 (DVD), and 0.47 (CD); and the element thicknesses are 0.25 mm (the optical element) and 2.23 mm (the converging lens element). The effective diameters are a value for the first surface (surface number 1 in Table 8) of the optical element.

In reality, the magnification is changed for each wavelength by using a magnification converting element such as a collimating lens, but only the distance of an optical virtual object point is shown here.

Tables 10 to 12 show parameters of each surface of the optical element and the converging lens element.

TABLE 7

| | BD | DVD | CD |
|---|---|---|---|
| Wavelength | 0.408 | 0.658 | 0.785 |
| Effective diameter | 3.10 | 2.28 | 1.94 |
| NA | 0.86 | 0.6 | 0.47 |
| Working distance (WD) | 0.53 | 0.46 | 0.4 |
| Disc thickness (DT) | 0.0875 | 0.6 | 1.2 |
| Focal length | 1.8 | 2.0 | 2.2 |
| Diffraction order of first | 2 | −2 | −3 |
| region on first surface | | | |
| Diffraction order of second | 1 | −1 | — |
| region on first surface | | | |
| Diffraction order of third | 1 | — | — |
| region on first surface | | | |
| Diffraction order of first | 2 | 1 | 1 |
| region on second surface | | | |
| Object point | ∞ | −70 | 100 |

TABLE 8

| | Radius of | | | |
|---|---|---|---|---|
| | curvature at | | | |
| Surface | the top of | | | |
| No. | lens surface | Thickness | Material | Remarks |
| 0 | | OP | | |
| 1 | ∞ | 0.25 | | First region (diffractive |
| | | | | surface), second region |
| | | | | (diffractive surface), |
| | | | | third region (diffractive |
| | | | | surface) |
| 2 | −15.386776 | 0.1 | n1 | First region (diffractive |
| | | | | surface), second region |
| | | | | (aspherical surface), |
| | | | | third region (aspherical |
| | | | | surface) |
| 3 | 1.265441 | 2.226 | n2 | Aspherical surface |
| 4 | −3.215648 | WD | | Aspherical surface |
| 5 | ∞ | DT | Disc | Planar |
| 6 | ∞ | | | Planar |

TABLE 9

| Wavelength | 408 | 658 | 785 |
|---|---|---|---|
| n1 | 1.52245912 | 1.50461749 | 1.50145399 |
| n2 | 1.62340933 | 1.60285214 | 1.59879881 |
| Disc | 1.61641628 | 1.5782857 | 1.57203127 |

TABLE 10

| First surface | First region, planar |
|---|---|
| | Diffractive surface |
| Region | 0 mm to 0.97 mm |
| RD | ∞ |
| First surface | First region, phase function |
| | Diffractive surface |
| P2 | −119.21157 |
| P4 | 3.5025826 |
| P6 | −3.6491801 |
| P8 | −3.7582129 |
| P10 | −2.9694529 |
| First surface | Second region, planar |
| Region | 0.97 mm to 1.14 mm |
| | Diffractive surface |
| RD | ∞ |
| First surface | Second region, phase function |
| | Diffractive surface |
| P2 | 1558.14492 |
| P4 | −5970.4588 |
| P6 | 7264.8576 |
| P8 | −3861.5446 |
| P10 | 757.3283 |
| First surface | Third region, planar |
| Region | 1.14 mm to 1.55 mm |
| | Diffractive surface |
| RD | ∞ |
| First surface | Third region, phase function |
| | Diffractive surface |
| P2 | 67.452228 |
| P4 | −896.34492 |
| P6 | 905.69384 |
| P8 | −386.77812 |
| P10 | 59.570708 |

TABLE 11

| Second surface | First region, aspherical constants |
|---|---|
| Region | 0 mm to 1.00 mm |
| | Diffractive surface |
| RD | −15.386776 |
| CC | 0 |
| A2 | 0 |
| A4 | 0.09187567 |
| A6 | −0.17496666 |
| A8 | 0.14358009 |
| A10 | −0.10617331 |
| A12 | 0.064032583 |
| A14 | −0.027741185 |
| A16 | 0.000509271 |
| Second surface | First region, phase function |
| | Diffractive surface |
| P2 | 250 |
| P4 | −377.2417 |
| P6 | 722.08042 |
| P8 | −539.82961 |
| P10 | 237.68701 |
| Second surface | Second region, aspherical constants |
| Region | 1.00 mm to 1.16 mm |
| | Aspherical surface |
| RD | 14.860695 |
| CC | 0 |
| A0 | −0.11944236 |
| A2 | 0 |
| A4 | 0.25989607 |
| A6 | −0.32580863 |
| A8 | 0.050491504 |
| A10 | 0.082581323 |
| A12 | −0.008629941 |
| A14 | −0.022153477 |
| A16 | 0.005744974 |
| Second surface | Third region, aspherical constants |
| Region | 1.16 mm to 1.55 mm |
| | Aspherical surface |
| RD | 21.083531 |
| CC | 0 |
| A0 | −0.080653767 |
| A2 | 0 |
| A4 | 0.039530909 |
| A6 | −0.030631719 |
| A8 | −0.000542363 |
| A10 | 0.003958124 |
| A12 | 0.002189094 |
| A14 | −0.001685793 |
| A16 | 0.000247604 |

TABLE 12

| Third surface | Aspherical surface |
|---|---|
| RD | 1.265441 |
| CC | −0.5812379 |
| A2 | 0 |
| A4 | 0.006986459 |
| A6 | 0.002037071 |
| A8 | 0.000346491 |
| A10 | 0.001039879 |
| A12 | −0.00062667 |
| A14 | 1.32E−05 |
| A16 | 0.000224171 |
| A18 | −9.82E−05 |
| A20 | −3.03E−06 |
| A22 | 3.20E−06 |
| Fourth surface | Aspherical surface |
| RD | −3.215648 |
| CC | 0 |
| A2 | 0 |
| A4 | 0.38215302 |
| A6 | −0.44938421 |
| A8 | 0.12916036 |
| A10 | 0.14203417 |
| A12 | 0.009984572 |
| A14 | −0.1468925 |
| A16 | −0.051821231 |
| A18 | 0.18889754 |
| A20 | −0.097072681 |
| A22 | 0.012831712 |

The objective lens system including the optical element according to the present invention can be used, for example, for an optical pickup device which is incorporated into an information apparatus such as a personal computer, a video apparatus such as an optical disc recorder, or an audio apparatus.

While the invention has been described in detail, the foregoing description is in all aspects illustrative and not restrictive. It will be understood that numerous other modifications and variations can be devised without departing from the scope of the invention.

What is claimed is:

1. An optical element comprising a plurality of periodic stair-like structures and a periodic sawtooth-like structure on a first optical surface.

2. The optical element according to claim 1, wherein
the first optical surface is divided into an inner region including a rotational symmetry axis, and an outer region surrounding the inner region,
the periodic stair-like structures are provided on the inner region, and
the periodic sawtooth-like structure is provided on the outer region.

3. The optical element according to claim 1, wherein a periodic sawtooth-like structure is provided on a second optical surface different from the first optical surface.

4. The optical element according to claim 3, wherein
the second optical surface is divided into an inner region including a rotational symmetry axis, and an outer region surrounding the inner region,
the periodic sawtooth-like structure is provided on the inner region of the second optical surface, and
the outer region of the second optical surface is formed by an aspheric surface.

5. An optical pickup device comprising:
a light source;
an objective lens system converging light emitted from the light source, to form a spot on an information recording surface of an optical information storage medium; and
a detector detecting light reflected by the information recording surface, wherein
the objective lens system includes:
an optical element according to claim 1; and
a converging lens element converging light emitted from the optical element, to form a spot on the information recording surface of the optical information storage medium.
